(19) United States
(12) Patent Application Publication
(10) Pub. No.: US 2024/0125310 A1
(43) Pub. Date: Apr. 18, 2024

(54) SEALING ASSEMBLY AND HYDRAULIC PISTON PUMP / MOTOR

(71) Applicant: Dana Motion Systems Italia S.R.L., Reggio Emilia (IT)

(72) Inventor: Piergiorgio TRINCHIERI, Reggio Emilia (IT)

(21) Appl. No.: 18/485,935

(22) Filed: Oct. 12, 2023

(30) Foreign Application Priority Data
Oct. 13, 2022 (DE) 20 2022 105 805.9

(51) Int. Cl. F04B 1/122; F04B 53/16

(52) U.S. Cl. CPC F04B 1/122; F04B 53/16

(57) ABSTRACT

The present disclosure relates to a sealing assembly for a hydraulic piston pump/motor. The sealing assembly comprises a cylinder block, a fluid distribution member, and a sealing member disposed between the cylinder block and the fluid distribution member. The sealing member encloses and seals a fluidic connection between the cylinder block and the fluid distribution member. The present disclosure further relates to a hydraulic piston pump/motor comprising said sealing assembly.

### CROSS-REFERENCE TO RELATED APPLICATION

The present application claims priority to German Utility Model Application No. 20 2022 105 805.9, entitled “SEALING ASSEMBLY AND HYDRAULIC PISTON PUMP/MOTOR”, and filed Oct. 13, 2022. The entire contents of the above-listed application is hereby incorporated by reference for all purposes.

### TECHNICAL FIELD

The present disclosure relates to a sealing assembly and to a hydraulic piston pump and/or to a hydraulic piston motor including said sealing assembly.

### BACKGROUND AND SUMMARY

During operation of a piston pump/motor, sudden changes in displacement and rotation may be performed which may detach a cylinder block from a fluid distribution member fluidically connected to the cylinder block, thereby possibly causing a substantial increase in oil leakage and, therefore, a drainage flow rate at the moment of the operation.

Furthermore, a tool operated by the piston pump or motor, such as a soil drilling apparatus, may get stuck in the ground, thereby causing pressure peaks which tend to detach the cylinder block from the distribution plate. If the leakage flow rate is excessive this can create a high pressure in the pump housing which can damage the seal on the pump shaft.

U.S. Pat. No. 4,046,029 A discloses a hydromechanical transmission including an input shaft, an axial piston hydraulic pump assembly associated with the shaft to be driven thereby, a pivotal swash plate operatively associated with the pump for selectively varying the displacement thereof, an axial piston hydraulic motor assembly coaxial with the pump, and a floating valve plate disposed between and engaging the pump and motor. A sun gear is carried by the motor, while a ring gear is carried by the pump. A rotatable output carrier is coaxial with the shaft and carries at least one planet gear engaged with both the sun and ring gears. The output of the transmission is taken from the carrier.

It is therefore an object of the present disclosure to reduce leakage in a hydraulic piston pump/motor.

This object is solved by a sealing assembly and by a hydraulic piston pump/motor including said sealing assembly. Special embodiments are described herein.

The proposed sealing assembly for a hydraulic piston unit such as a hydraulic pump or motor comprises a cylinder block, a fluid distribution member, and a sealing member disposed between the cylinder block and the fluid distribution member, the sealing member enclosing and sealing a fluidic connection between the cylinder block and the fluid distribution member. Within the scope of this document, the term fluid may include a liquid such as oil.

By way of the sealing member the connection between the cylinder block and the fluid distribution member is strengthened and sealed, thereby reducing or preventing fluid leakage such as during pressure peaks.

The sealing member may have an annular shape, thereby allowing for a seal that surrounds the potential area of leakage.

The fluid distribution member may comprise a valve plate, with said valve plate being optionally movable to allow varying a stroke of the pistons and a hydaulic displacement of the hydraulic piston unit.

In an example, the fluid distribution member may comprise a first fluid port for supplying fluid to the cylinder block and a second fluid port for receiving fluid from the cylinder block. The sealing member may enclose the first fluid port and the second fluid port of the fluid distribution member, thereby sealing off or reducing potential leakage of fluid from the fluid ports.

Typically, the cylinder block comprises a plurality of cylinders, and the hydraulic piston unit includes a plurality of pistons received in the cylinders and configured to reciprocate in the cylinders. The cylinder block and/or the pistons may be coupled with a pump shaft or motor shaft. Usually, the cylinders formed in the cylinder block are in fluidic communication with the fluid ports of the fluid distribution member via the fluidic connection between the cylinder block and the fluid distribution member enclosed and sealed by the sealing member.

In order to keep the sealing member in a predetermined position, the sealing assembly may further comprise a groove formed in the cylinder block or formed in the fluid distribution member. The sealing member may then be disposed at least partially within the groove.

The sealing member may additionally feature a notch providing fluidic communication between the groove and a low pressure side of the sealing member, so that the notch may release any pressure created in the groove, such as to prevent unwanted thrust load.

For example, the cylinder block and the fluid distribution member may form a clearance therebetween, the notch and the clearance providing fluidic communication between the groove and ambient pressure.

In an example, the sealing member features a notch providing fluid communication between the groove and a high pressure side of the sealing member. For example, high pressure fluid entering the groove may bias or additionally bias the sealing member received or partially received in the groove against the cylinder block or against the fluid distribution member.

Optionally, the sealing assembly may further comprise at least one biasing member. The at least one biasing member may be supported on the cylinder block in such a way that said biasing member biases the sealing member toward the fluid distribution member, or, alternatively, the at least one biasing member may be supported on the fluid distribution member and biases the sealing member toward the cylinder block.

The at least one biasing member may bias the sealing member against either the cylinder block or the distribution member. In this way, the biasing member may seal the fluidic connection between the cylinder block and the fluid distribution member even when the cylinder block and distribution member are momentarily displaced, for example due to pressure peaks.

The biasing member may for example comprise a wave spring disposed within the groove, with said wave spring for example extending around at least 50% of the groove, for instance around at least 80% of the groove or around the entire groove. For example, a wave spring that extends around a majority of the groove exert a constant or essentially constant pressure or force on the sealing member along its circumference.

Alternatively, the biasing member may comprise at least two helical springs disposed within holes extending from the groove. The helical springs can be arranged around the groove, for example at regular intervals, so that a near constant pressure or force may be maintained on the sealing member along its circumference. There may be several helical springs, for example 4 to 8 helical springs disposed around the groove.

The sealing member may thereby be in sealing contact with the cylinder block or with the fluid distribution member, depending on the arrangement.

In an example, the sealing member may be configured such that it contacts the cylinder block or the fluid distribution member adjacent to a high pressure side of the sealing member. The high pressure side of the sealing member may be a radially inner side of the sealing member facing the fluidic connection between the cylinder block and the fluid distribution member sealed by the sealing member.

Furthermore, it is possible that a contact face of the sealing member contacting the cylinder block or contacting the fluid distribution member has an arcuate cross section so that the sealing member contacts the cylinder block or the fluid distribution member in between a high pressure side and a low pressure side of the sealing member. The low pressure side of the sealing member may be a radially outer side of the sealing member facing away from the fluidic connection between the cylinder block and the fluid distribution member sealed by the sealing member.

Alternatively, the sealing member may be configured such that it contacts the cylinder block or the fluid distribution member adjacent to the low pressure side of the sealing member.

Optionally, the sealing member may be made of metal such as hardened and ground high-resistance steel material or of anti-friction bronze.

The sealing member being made of hardened and ground high-resistance steel material typically enhances the durability of the sealing member. For example, over time, friction between the sealing member and the cylinder block or the fluid distribution member may form or leave a trace on the latter, respectively, which may further improve the sealing properties of the sealing member. By contrast, when the sealing member is alternatively made of anti-friction bronze, the sealing member may wear out over time, thereby adapting to the profile of the cylinder block or of the fluid distribution member and possibly improving the its sealing properties.

This disclosure furthermore also relates to a hydraulic piston unit such as a hydraulic pump or a hydraulic motor comprising the sealing assembly described above, wherein the cylinder block is rotatable relative to the fluid distribution member.

The hydraulic piston unit may be configured as an axial piston pump/motor, for example, the hydraulic piston pump/motor may be configured as an axial piston pump/motor of the bent axis type. Alternatively, the hydraulic piston pump or motor may be configured as an axial piston pump/motor of the straight axis type wherein the hydraulic piston pump or motor of the straight axis type further comprises a swash plate, for example.

Embodiments of the subject matter proposed in the present application are illustrated in the accompanying drawings and are further described in the following detailed description with respect to the following figures, wherein

### BRIEF DESCRIPTION OF THE FIGURES

FIGS. 1A, 1B show perspective views of a hydraulic piston unit such as a pump or motor;

FIG. 2A, 2B show sections of the hydraulic piston unit of FIGS. 1A and 1B;

FIG. 3 shows a hydrostatic transmission including the hydraulic piston unit of FIGS. 1 and 2;

FIG. 4A shows a section of a sealing assembly of the hydraulic unit of FIGS. 1 and 2 according to a first embodiment;

FIG. 4B shows a section of a sealing assembly of the hydraulic unit of FIGS. 1 and 2 according to a second embodiment;

FIG. 4C shows a section of a sealing assembly of the hydraulic unit of FIGS. 1 and 2 according to a third embodiment;

FIG. 5A shows a section of a hydraulic unit such as a pump or motor according to a further embodiment;

FIG. 5B, 5C show sections of the hydraulic piston unit of FIG. 5A;

FIG. 6 shows a section of a hydraulic piston unit such as a pump or motor according to a further embodiment.

### DETAILED DESCRIPTION

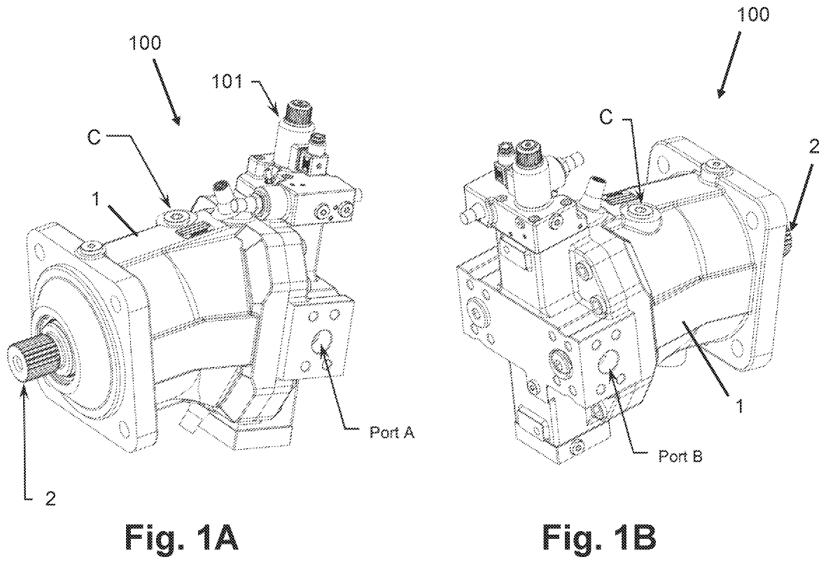

FIGS. 1A and 1B show different perspective views of an embodiment of a hydraulic piston unit 100 of the presently proposed type. The hydraulic piston unit 100 is of the bent-axis type and may be used as a hydraulic pump and/or as a hydraulic motor, as is generally known in the art of hydraulic devices. Here and in all of the following, features recurring in different figures are designated with the same reference signs.

The hydraulic piston unit 100 comprises a housing 1, an inlet port A, an outlet port B, a drainage port C for draining internally leaked fluid, a rotatable shaft 2, for example a motor shaft or pump shaft, for transmitting rotary motion, and an electric control 101 for regulating a hydraulic displacement of the hydraulic piston unit 100.

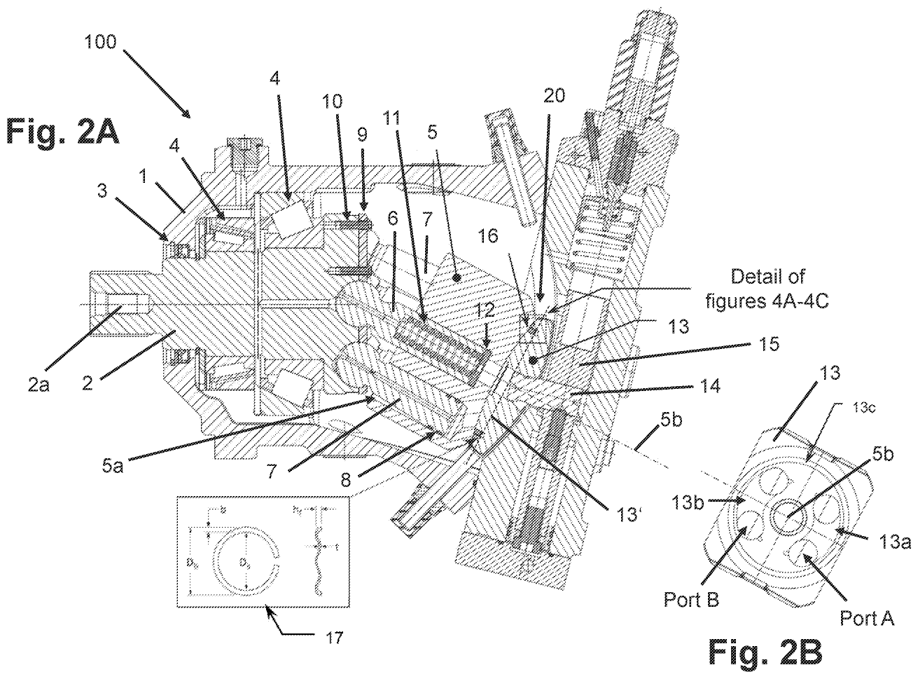

FIG. 2A shows a cross-sectional view of the hydraulic piston unit 100 of FIGS. 1A and 1B. High pressure fluid may be supplied to port A of the hydraulic piston unit 100. Port A is fluidically connected to a first curved slot 13a in a fluid distribution member 13, here in the form of a valve plate. The fluid distribution member 13 further includes a second curved slot 13b fluidically connected to the port B of the hydraulic piston unit 100. The fluid distribution member 13 is fixed relative to the housing 1. Via the slot 13a in the fluid distribution member 13, high pressure fluid from port A may be supplied to a subset of a plurality of cylinders 5a formed in a cylinder block 5. Pistons 7 equipped with metal ring seals 8 are disposed within the cylinders 5a and may reciprocate in the cylinders 5a. The cylinder block 5 is rotatable with respect to a rotation axis 5b relative to the housing 1 and relative to the fluid distribution member 13. The cylinder block 5 is coupled to the rotatable shaft 2 via the pistons 7.

On the rotation axis 5b of the cylinder block 5 a central piston 6 is hinged to the shaft 2 via a spherical terminal. The pistons 7 also each have a spherical terminal hinged to the shaft 2. Here, the pistons 7 are locked with a perforated plate 9 fixed to the cylinder block 5 with screws 10.

A spring 11 received in a hollow formed in the central piston 6 and supported on the central piston 6 biases the cylinder block 5 toward the fluid distribution member 13. A spacer washer 12 is received in a cylinder 5a which houses the central piston 6. A clearance between the spacer washer 12 and the central piston 6 determines by how much the cylinder block 5 may detach from the fluid distribution member 13 along the rotation axis 5b of the cylinder block 5 during operation. The maximum clearance between the central piston 6 and the cylinder block 5 may have a length of between 0.3 mm and 1.2 mm, for example. The shaft 2 is held in position in the housing 1 by bearings 4. A seal 3 disposed between the shaft 2 and the housing 1 prevents fluid such as oil from leaking from the housing 1.

As is generally known in the art of bent-axis piston pumps or motors, an inclination between the rotation axis 5b of the cylinder block 5 with respect to a rotation axis 2a of the shaft 2 determines a stroke of the pistons 7 and the hydraulic displacement of the hydraulic piston unit 100, i. e. the amount of fluid displaced by the hydraulic piston unit 100 upon a complete turn of the shaft 2.

When high pressure fluid is supplied to the port A of the hydraulic piston unit 100, it pushes those of the pistons 7 received in cylinders 5a in fluidic communication with the port A via the slot 13a in the fluid distribution member 13 out of the cylinder block 5, thereby causing the cylinder block 5 and the shaft 2 to rotate relative to the housing 1. At the same time, those of the pistons 7 received in cylinders 5a in fluidic communication with the port B via the slot 13b in the fluid distribution member 13 displace fluid out of the cylinder block 5 and toward the port B.

By moving a piston 15 which is hinged to the fluid distribution member 13 by means of a pin 14, the hydraulic displacement of the hydraulic piston unit 100 can be varied by changing the inclination of the rotation axis 5b of the cylinder block 5 with respect to the rotation axis 2a of the shaft 2.

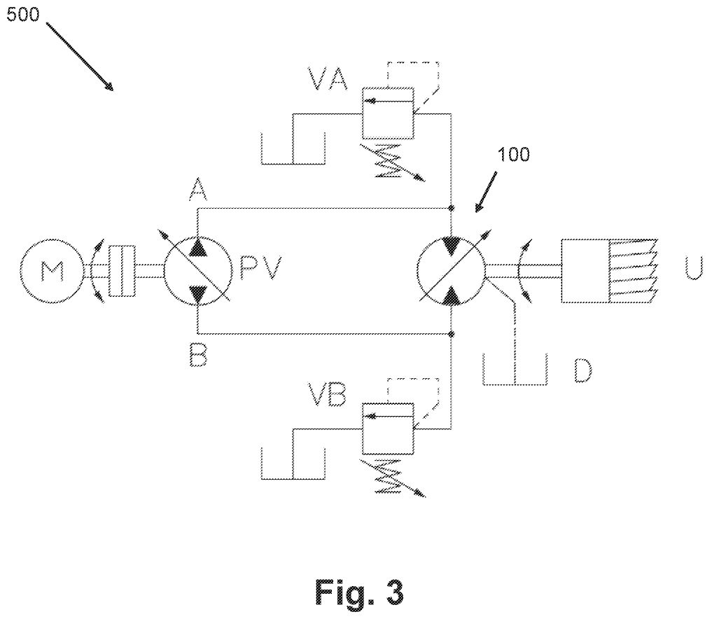

FIG. 3 shows an embodiment of a hydrostatic transmission 500 including a hydraulic pump PV in fluidic communication with the hydraulic piston unit 100 of FIGS. 1 and 2, here used as a hydraulic motor. Here, the hydraulic piston unit 100 drives a drilling tool U. Fluid leaked within the hydraulic piston unit 100 is collected in a drainage channel D connected to a tank. When a pressure in the system exceeds a threshold pressure, fluid from the circuit including the pump PV and the hydraulic piston unit 100 may be drained to the tank via pressure relief valves VA, VB.

During operation of the hydraulic piston unit 100, sudden changes in displacement and/or rotational speed of the shaft 2 may occur which may detach the cylinder block 5 from the fluid distribution member 13. Furthermore, in the hydrostatic transmission 500 of FIG. 3, the drilling tool U can get stuck in the ground causing pressure peaks within the hydraulic piston unit 100 which may detach the cylinder block 5 from the fluid distribution member 13. Thus, if a fluid connection between the slots 13a, 13b in the fluid distribution member 13 and the cylinders 5a of the cylinder block 5 is not sufficiently sealed, the detachment of the cylinder block 5 from the fluid distribution member 13 may cause fluid leakage between the cylinder block 5 and the fluid distribution member 13. If the leakage flow rate is excessive, this may create a high pressure in the housing 1 and may damage the seal 3 between the shaft 2 and the housing 1, for example.

To address these issues, the hydraulic piston unit 100 of FIGS. 1-3 includes a sealing assembly 20. The sealing assembly 20 includes the cylinder block 5, the fluid distribution member 13 and a sealing member 16 disposed between the cylinder block 5 and the fluid distribution member 13 and sealing the fluidic connection between the cylinder block 5 and the fluid distribution member 13. More specifically, the sealing member 16 encloses and seals the fluidic connection between the slots 13a, 13b in the fluid distribution member 13 and the cylinders 5a of the cylinder block 5. In the embodiment depicted here, the sealing member 16 comprises or is configured as an annular metal ring. The sealing assembly 20 further includes a groove 13c formed in the fluid distribution member 13, and a biasing member 17. Here, the groove 13c has an annular shape. The annular groove 13c is arranged symmetrically with respect to the rotation axis 5b of the cylinder block 5. The sealing member 16 is partially received in the annular groove 13c. The biasing member 17 is disposed in the annular groove 13c in between the fluid distribution member 13 and the sealing member 16. FIG. 2B illustrates a cross section of the fluid distribution member 13 of FIG. 2A including the annular groove 13c along a sectional plane 13′ perpendicular to the rotation axis 5b of the cylinder block 5.

In the embodiment depicted in FIG. 2A, the biasing member 17 is or includes a wave spring. The biasing member 17 is supported on the fluid distribution member 13 and biases the sealing member 16 towards the cylinder block 5. That is, the biasing member 17 presses the sealing member 16 against the cylinder block 5 so that the sealing member 16 is in sealing contact with the cylinder block 5. A height and an elasticity of the biasing member 17 along the rotation axis 5b of the cylinder block 5 are typically chosen such that the biasing member 17 forces the sealing member 16 into sealing contact with the cylinder block 5 also when the cylinder block 5 detaches from the fluid distribution member 13, for example within the axial play determined by the maximum clearance between the fluid distribution member 13 and the central piston 6, as described above. In this way, leakage between the fluid distribution member 13 and the cylinder block 5 may be significantly reduced or entirely prevented.

The sealing member 16 can be made of hardened and ground high-resistance steel material, for example. In this case, friction between the sealing member 16 and the cylinder block 5 may leave or form a trace on the cylinder block 5. Alternatively, the sealing member 16 can be made of anti-friction bronze. In this case, the sealing member 16 may wear out over time, thereby adapting to the profile of the cylinder block 5.

The material of the sealing member 16 may be selected to allow the sealing member 16 to withstand very high pressures, for example a maximum pressure of at least 200 bar or of at least 450 bar at a maximum clearance between the cylinder block 5 and the fluid distribution member 13 of up to 1.2 mm, without being damaged.

Alternatively, the sealing member 16 may be made of or may comprise a non-metal material, for instance as long as the material satisfies the requirements set out above regarding pressure and durability. Also, in alternative embodiments the shape of the sealing member 16 may not be annular but may be oval, or rectangular (possibly with rounded corners), for example. In this case, a shape of the groove 13c in which the sealing member 16 is at least partially received is adapted accordingly.

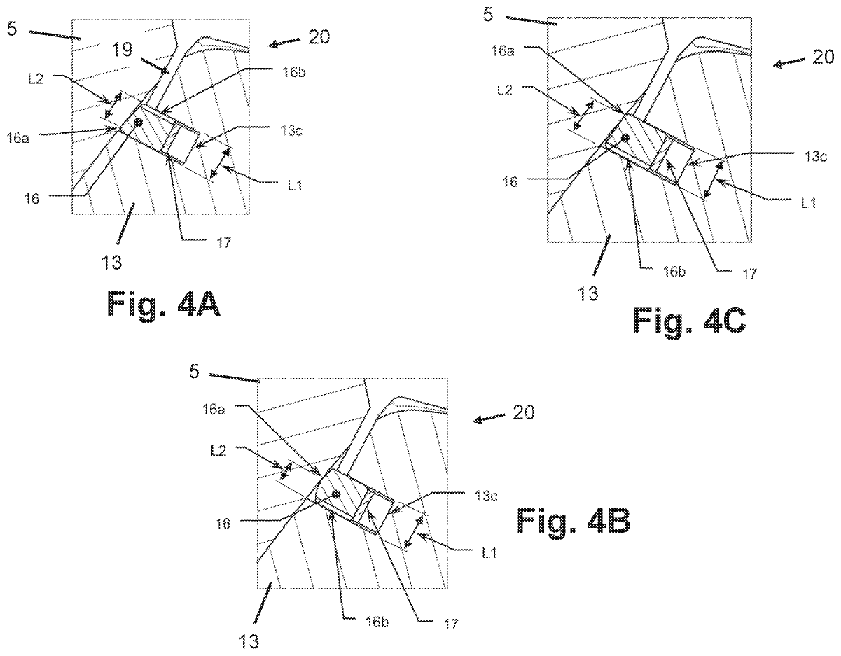

FIG. 4A shows a detail of FIG. 2A according to a first embodiment of the sealing assembly 20. In the embodiment of the sealing assembly 20 shown in FIG. 4A, a face of the sealing member 16 facing the cylinder block 5 is inclined with respect to a face of the cylinder block 5 facing the fluid distribution member 13. More specifically, a cross section of the sealing member 16 in a sectional plane including the rotation axis 5b of the cylinder block 5 is shaped such the annular sealing member 16 is in sealing contact with the cylinder block 5 along an annular contact zone 16a at or adjacent to a high pressure side of the sealing member 16. The high pressure side of the annular sealing member 16 is the radially inner side of the annular sealing member 16 facing the fluidic connection between the cylinder block 5 and the fluid distribution member 13 enclosed and sealed by the sealing member 16.

Further in the embodiment of FIG. 4A, the sealing member 16 features a notch 16b. The notch 16b extends in parallel to the rotation axis 5b of the cylinder block 5 along the entire axial height of the sealing member 16. The notch 16b provides fluidic communication between the groove 13c and a low pressure side of the sealing member 16, more specifically between the low pressure side of the sealing member 16 and a portion of the groove 13c extending between the fluid distribution member 13 and the sealing member 16 along the rotation axis 5b of the cylinder block 5. The low pressure side of the annular sealing member 16 is the radially outer side of the annular sealing member 16 facing away from the fluidic connection between the cylinder block 5 and the fluid distribution member 13 enclosed and sealed by the sealing member 16. Via the notch 16b and a clearance 19 formed in between the cylinder block 5 and the fluid distribution member 13, the groove 13c is in fluidic communication with ambient pressure. The notch 16b allows pressure equalisation between the groove 13c and the low pressure side of the sealing member 16, thereby facilitating movement of the sealing member 16 in parallel to the rotation axis 5b of the cylinder block 5. Surfaces L1 and L2 of the sealing member 16 perpendicular to the rotation axis 5b of the cylinder block 5 have equal areas and are both in fluidic communication with the low pressure side of the sealing member 16. Consequently, in parallel to the rotation axis 5b of the cylinder block 5 no net force is exerted on the sealing member 16 by a pressure on the high pressure side or by a pressure on the low pressure side of the sealing member 16.

FIG. 4B shows the detail of FIG. 2A according to a second embodiment of the sealing assembly 20. In the embodiment of the sealing assembly 20 shown in FIG. 4B, a face of the sealing member 16 facing the cylinder block 5 has an arcuate or convex shape. More specifically, a cross section of the sealing member 16 in a sectional plane including the rotation axis 5b of the cylinder block 5 is shaped such the annular sealing member 16 is in sealing contact with the cylinder block 5 along an annular contact zone 16a in between the high pressure side and the low pressure side of the sealing member 16, for example half way or about half way between the high pressure side and the low pressure side of the sealing member 16.

Further in the embodiment of FIG. 4B, the sealing member 16 features a notch 16b. The notch 16b extends in parallel to the rotation axis 5b of the cylinder block 5 along the entire axial height of the sealing member 16. The notch 16b provides fluidic communication between the groove 13c and the high pressure side of the sealing member 16, more specifically between the high pressure side of the sealing member 16 and a portion of the groove 13c extending between the fluid distribution member 13 and the sealing member 16 along the rotation axis 5b of the cylinder block 5. In this way, lubricant from the fluidic connection between the fluid distribution member 13 and the cylinder block may lubricate the contact zone 16a between the sealing member 16 and the fluid distribution member 13. Surfaces L1 and L2 of the sealing member 16 perpendicular to the rotation axis 5b of the cylinder block 5 and in fluidic communication with the high pressure side of the sealing member 16 have different areas. More specifically, in the embodiment shown in FIG. 4B the surface L2 of the sealing member 16 which faces the cylinder block 5 and which is fluidically connected to the high pressure side of the sealing member 16 is smaller than the surface L1 of the sealing member 16 which faces away from the cylinder block 5 and which is fluidically connected to the high pressure side of the sealing member 16 via the notch 16b. Consequently, in the embodiment of FIG. 4B a hydraulic pressure acting on the surfaces L1, L2 of the sealing member 16 creates a net force biasing or forcing the sealing member 16 toward and/or against the cylinder block 5, in addition to the load or bias generated by the biasing member 17. In this way, the biasing member 17 can be designed to exert a smaller biasing force on the sealing member 16. Also, a greater biasing force biasing the sealing member 16 toward and/or against the cylinder block 5 is automatically generated when the hydraulic pressure on the high pressure side of the sealing member 16 increases.

FIG. 4C shows the detail of FIG. 2A according to a third embodiment of the sealing assembly 20. In the embodiment of the sealing assembly 20 shown in FIG. 4C, a face of the sealing member 16 facing the cylinder block 5 is inclined with respect to a face of the cylinder block 5 facing the fluid distribution member 13. More specifically, a cross section of the sealing member 16 in a sectional plane including the rotation axis 5b of the cylinder block 5 is shaped such the annular sealing member 16 is in sealing contact with the cylinder block 5 along an annular contact zone 16a at or adjacent to the low pressure side of the sealing member 16. In this way, lubricant from the fluidic connection between the fluid distribution member 13 and the cylinder block 5 enclosed and sealed by the sealing member 16 may be provided to the contact zone 16a between the sealing member 16 and the cylinder block 5.

Further in the embodiment of FIG. 4C, the sealing member 16 features a notch 16b. The notch 16b extends in parallel to the rotation axis 5b of the cylinder block 5 along the entire axial height of the sealing member 16. The notch 16b provides fluidic communication between the groove 13c and the high pressure side of the sealing member 16, more specifically between the high pressure side of the sealing member 16 and a portion of the groove 13c extending between the fluid distribution member 13 and the sealing member 16 along the rotation axis 5b of the cylinder block 5. In this way, lubricant from the fluidic connection between the fluid distribution member 13 and the cylinder block may lubricate the contact zone 16a between the sealing member 16 and the fluid distribution member 13. Surfaces L1 and L2 of the sealing member 16 perpendicular to the rotation axis 5b of the cylinder block 5 have equal areas and are both in fluidic communication with the high pressure side of the sealing member 16. Consequently, in parallel to the rotation axis 5b of the cylinder block 5 no net force is exerted on the sealing member 16 by a pressure on the high pressure side or by a pressure on the low pressure side of the sealing member 16.

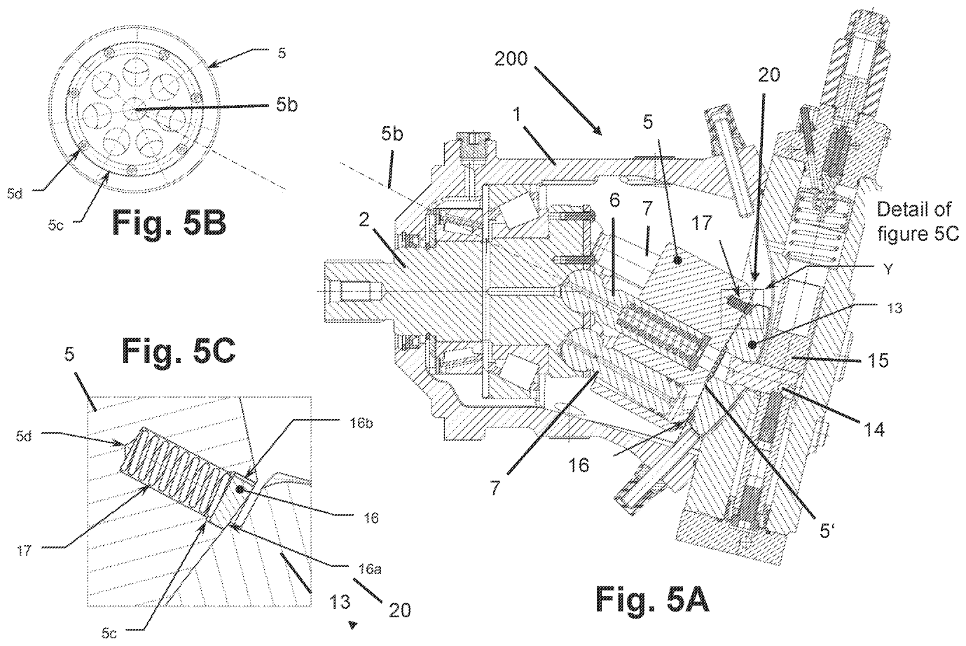

FIG. 5A shows another embodiment of a hydraulic piston unit 200 including a sealing assembly 20 of the presently proposed type. The hydraulic piston unit 200 is of the bent-axis type and may be used as a hydraulic pump or as a hydraulic motor. The hydraulic piston unit 200 of FIG. 5A is a variant of the hydraulic piston unit 100 of FIG. 2A. For the sake of brevity and simplicity, in the following only those features which distinguish the hydraulic piston unit 200 of FIG. 5A from the hydraulic piston unit 100 of FIG. 2A will be described in some detail. As before, features recurring in different figures are designated with the same reference signs. In FIG. 5A, the sealing assembly 20 includes a fluid distribution member 13 in the form of a valve plate, a cylinder block 5 and a sealing member 16 disposed between the fluid distribution member 13 and the cylinder block 5. Again, the sealing member 16 encloses and seals a fluidic connection between the fluid distribution member 13 and the cylinder block 5. The sealing member 16 has a circular or annular shape and may be made of a metal material, for example. The sealing member 16 is arranged symmetrically with respect to the rotation axis 5b of the cylinder block 5.

In contrast to the embodiment of FIG. 2A, in the embodiment of FIG. 5A the sealing assembly 20 includes a groove 5c formed in the cylinder block 5. FIG. 5B illustrates a cross section of the cylinder block 5 of FIG. 5A including the annular groove 5c along a sectional plane 5′ perpendicular to the rotation axis 5b of the cylinder block 5. The sealing member 16 is at least partially received in the annular groove 5c. The cylinder block 5 further features holes or borings 5d extending from the annular groove 5c. The holes 5d may be disposed at equal angular distances from one another, for example. A biasing member 17 in the form of a helical spring is disposed in each of the holes 5d. The biasing members 17 are supported on the cylinder block 5 and bias the sealing member 16 into sealing contact or sealing engagement with the fluid distribution member 13.

FIG. 5C shows a detail of FIG. 5A illustrating the sealing assembly 20 including the groove 5c, the sealing member 16 received in the groove 5c, and one of the biasing members 17 received in one of the holes 5d. An annular contact zone 16a of the sealing member 16 along which the sealing member 16 is in sealing contact with the fluid distribution member 13 is adjacent to the high pressure side of the sealing member 16. A notch 16b formed in the sealing member 16 establishes fluidic communication between the groove 5c and the hole 5d and the low pressure side of the sealing member 16. In this way, an excess pressure that may be created in the groove 5c may be released via the notch 16b.

Even though not shown in the drawings, in alternative embodiments of the sealing assembly 20 the groove 5c formed within the cylinder block 5 may be combined with a biasing member 17 in the form of a single continuous wave spring disposed within the groove and biasing the sealing member 16 into sealing engagement with the fluid distribution member 13, similar to the embodiment of FIG. 2A.

And in further alternative embodiments of the sealing assembly 20 not explicitly depicted here, a groove formed in the fluid distribution member 13 may be combined with a series of helical springs located in holes extending from said groove, similar to the embodiment of FIG. 5A.

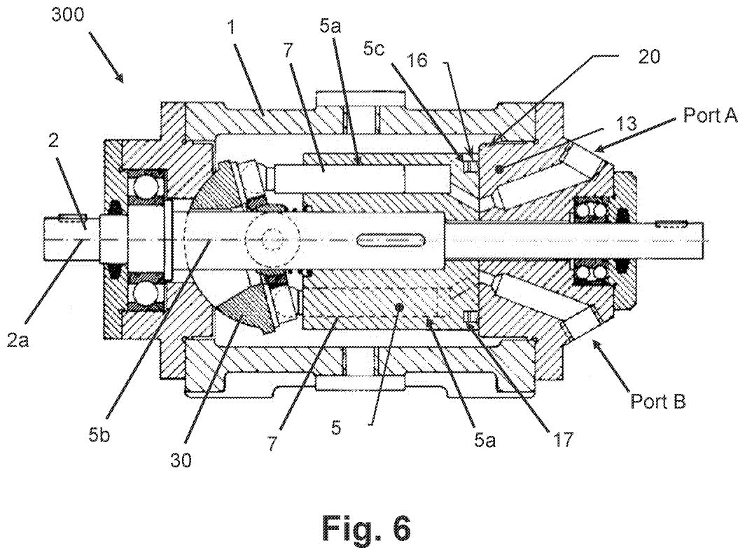

FIG. 6 shows an embodiment of a hydraulic piston unit 300 including a sealing assembly 20 of the presently proposed type. The hydraulic piston unit 300 is of the straight axis type and may be used as a hydraulic pump or as a hydraulic motor. The hydraulic piston unit 300 includes a housing 1 and a rotatable shaft 2 such as a pump shaft or motor shaft supported on the housing 1. The shaft 2 is coupled to a cylinder block 5 and may rotate therewith. A rotation axis 2a of the shaft 2 coincides with a rotation axis 5b of the cylinder block 5. Pistons 7 are received in cylinders 5a formed in the cylinder block 5 and may reciprocate therein. The pistons 7 are coupled to a swashplate 30. The swashplate 30 can be tilted with respect to a rotation axis which is arranged perpendicular to the axes 2a, 5a. An angle of the swashplate relative to the rotation axis 5a of the cylinder block 5 determines a stroke of the pistons 7 and, thus, a hydraulic displacement of the hydraulic piston unit 300. The cylinders 5a are in fluidic communication with fluid ports A and B of the hydraulic piston unit 300 via a fluid distribution member 13. Here, the fluid distribution member 13 is formed as a block which is rigidly attached to the housing 1. In alternative embodiments, the fluid distribution member 13 may possibly be made or formed in one piece with the housing 1.

Similar to the embodiment of FIG. 5A, the sealing assembly 20 of FIG. 6 includes a groove 5c formed in the cylinder block 5, a sealing member 16 at least partially received in the groove 5c, and a biasing member 17 disposed within the groove 5c, supported on the cylinder block 5 and biasing the sealing member 16 toward and into sealing engagement with the fluid distribution member 13, thereby enclosing and sealing the fluidic connection between the cylinder block 5 and the fluid distribution member 13. The groove 5c and the sealing member 16 may have an annular shape and may be arranged symmetrically with respect to the rotation axis 5b of the cylinder block 5.

Alternatively, the sealing assembly 20 of FIG. 6 may include a groove formed in the fluid distribution member 13 and a sealing member partially received in said groove, similar to the embodiment of FIG. 2A.

FIGS. 1A, 1B, 2A, 2B, 4A, 4B, 4C, 5A, 5B, 5C, and 6 are drawn to scale, although other relative dimensions may be used.

FIGS. 1-6 show example configurations with relative positioning of the various components. Unless otherwise noted, if shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example

1. A sealing assembly for a hydraulic piston pump/motor, comprising:
a cylinder block,
a fluid distribution member, and
a sealing member disposed between the cylinder block and the fluid distribution member, the sealing member enclosing and sealing a fluidic connection between the cylinder block and the fluid distribution member.

2. The sealing assembly of claim 1, wherein the sealing member has an annular shape.

3. The sealing assembly of claim 1, wherein the fluid distribution member comprises a first fluid port for supplying fluid to the cylinder block and a second fluid port for receiving fluid from the cylinder block, the sealing member enclosing the first fluid port and the second fluid port of the fluid distribution member.

4. The sealing assembly of claim 1, wherein the fluid distribution member comprises a valve plate.

5. The sealing assembly of claim 1, further comprising a groove formed in the cylinder block or formed in the fluid distribution member, the sealing member disposed at least partially within the groove.

6. The sealing assembly of claim 5, wherein the sealing member features a notch providing fluidic communication between the groove and a low pressure side of the sealing member.

7. The sealing assembly of claim 6, wherein the cylinder block and the fluid distribution member form a clearance therebetween, the notch and the clearance providing fluidic communication between the groove and ambient pressure.

8. The sealing assembly of claim 5, wherein the sealing member features a notch providing fluid communication between the groove and a high pressure side of the sealing member.

9. The sealing assembly of claim 1, further comprising at least one biasing member, wherein the at least one biasing member is supported on the cylinder block and biases the sealing member toward the fluid distribution member, or wherein the at least one biasing member is supported on the fluid distribution member and biases the sealing member toward the cylinder block.

10. The sealing assembly of claim 5, wherein the biasing member comprises a wave spring disposed within the groove.

11. The sealing assembly of claim 5, wherein the biasing member comprises at least two helical springs disposed within holes extending from the groove.

12. The sealing assembly of claim 1, wherein the sealing member is in sealing contact with the cylinder block or with the fluid distribution member.

13. The sealing assembly of claim 12, wherein the sealing member is configured such that it contacts the cylinder block or the fluid distribution member adjacent to a high pressure side of the sealing member.

14. The sealing assembly of claim 12, wherein a contact face of the sealing member contacting the cylinder block or contacting the fluid distribution member has an arcuate cross section so that the sealing member contacts the cylinder block or the fluid distribution member in between a high pressure side and a low pressure side of the sealing member.

15. The sealing assembly of claim 12 wherein the sealing member is configured such that it contacts the cylinder block or the fluid distribution member adjacent to a low pressure side of the sealing member.

16. The sealing assembly of claim 1, wherein the sealing member is made of metal.

17. The sealing assembly of claim 16, wherein the sealing member is made of hardened and ground high-resistance steel material or of anti-friction bronze.

18. A hydraulic piston pump/motor comprising the sealing assembly of claim 1, wherein the cylinder block is rotatable relative to the fluid distribution member.

19. The hydraulic piston pump/motor of claim 18, configured as an axial piston pump/motor.

20. The hydraulic piston pump/motor of claim 19, configured as an axial piston pump/motor of the bent-axis type.
